(19) United States
(12) Patent Application Publication
(10) Pub. No.: US 2007/0236928 A1
(43) Pub. Date: Oct. 11, 2007

(54) Light emitting decoration

(76) Inventor: Shu-Ching Hsu, Taipei (TW)

Correspondence Address: SHU-SHING HSU;235 Chung - Ho, Box 8-24, Taipei, TW

(21) Appl. No.: 11/401,438

(22) Filed: Apr. 11, 2006

(51) Int. Cl. F21V 9/00

(52) U.S. Cl. 362/231

(57) ABSTRACT

A light emitting decoration has a decoration unit having a colored and lighting decoration; the colored and lighting decoration being capable of refracting light as light passing therethrough; a light emitting unit having at least one transmission line which is bendable to be formed as a figure or characters; the transmission line being installed with a plurality of light emitting elements; the transmission line being wound and adhered to the colored and lighting decoration. The decoration has a ring which can be worn around a finger of a user. The light emitting unit has a control circuit board with predetermined control way; the control circuit board is installed with a battery as a power source and a switch key.

### FIELD OF THE INVENTION

The present invention relates to decorations, and in particular to a light emitting decoration which can present a beautiful outlook even no external light source exists, wherein a colored and lighting decoration of the present invention has the effect of lighting up by light emitting elements of a light emitting unit. Thus the present invention has the functions of refracting light so as to present a very beautiful effect.

### BACKGROUND OF THE INVENTION

Generally, decorations, such as rings, breast clips, belts, necklaces, are worn on the body of a user so as to present a beautiful outlook. To have more charming effect, a polyhedral manmade or natural diamond, crystal, jewel or glass are adhered to a decoration so as to present a charming light effect as light incidents upon the decoration.

However in above mention decoration, the light is from external light source. If the light cannot impinge upon the decoration, the effect cannot be presented.

Thus, there is an eager demand for a novel design which can improve the prior art defect so that the decoration can present a beautiful outlook even no external light source.

### SUMMARY OF THE INVENTION

Accordingly, the primary object of the present invention is to provide a light emitting decoration, wherein a colored and lighting decoration of the decoration have the effect of lighting up by light emitting elements of a light emitting unit. Thus the present invention has the functions of refracting light so as to present a very beautiful effect.

To achieve above objects, the present invention provides a decoration unit which has a ring and a colored and lighting decoration, for example a polyhedral manmade or natural diamond, crystal, jewel or glass so that when light passes through the colored and lighting decoration, the light is refracted to present a beautiful effect.

A light emitting unit has a control circuit board with predetermined control way. The control circuit board is installed with a battery as a power source and a switch key. The control circuit board is connected to at least one flexible transmission line. Thereby the transmission line can be bent to be formed as a figure or characters. The transmission line is installed with a plurality of small light emitting elements. The light emitting elements may have the same color or a plurality of colors. The battery of the control circuit board supplies power to the light emitting elements. The transmission line having the light emitting elements is wound and adhered to an inner wall of the colored and lighting decoration.

The various objects and advantages of the present invention will be more readily understood from the following detailed description when read in conjunction with the appended drawing.

### BRIEF DESCRIPTION OF THE DRAWINGS

FIG. 1 is an exploded schematic view about the first embodiment of the light emitting decoration of the present invention.

FIG. 2 is a schematic perspective view of the first embodiment of the light emitting decoration of the present invention.

FIG. 3 is a schematic cross sectional view of the first embodiment of the light emitting decoration of the present invention.

FIG. 4 is a schematic view of the present invention, which shows the use of the present invention.

FIG. 5A is an exploded schematic view of the second embodiment of the light emitting decoration of the present invention, where a first type is illustrated.

FIG. 5B is an exploded schematic view of the second embodiment of the light emitting decoration of the present invention, wherein a second type is illustrated.

FIG. 5C is an exploded schematic view of the second embodiment of the light emitting decoration of the present invention, wherein a third type is illustrated.

FIG. 6 is a schematic perspective view of the second embodiment of the light emitting decoration of the present invention.

FIG. 7 is a schematic perspective view of the second embodiment of the present invention, where the present invention is assembled to a breast clip.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

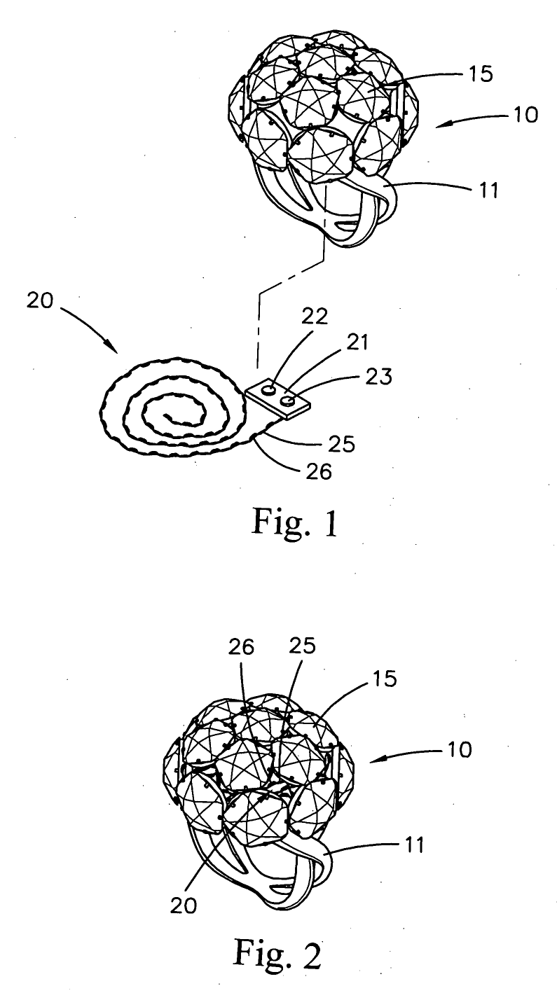

Referring to FIGS. 1 to 3, the structure of the present invention will be described herein.

A decoration unit 10 has a ring 11 and a colored and lighting decoration 15, for example a polyhedral manmade or natural diamond, crystal, jewel or glass so that when light passes through the colored and lighting decoration 15, the light is refracted to present a beautiful effect.

A light emitting unit 20 has a control circuit board 21 with predetermined control way. The control circuit board 21 is installed with a battery 22 as a power source and a switch key 23. The control circuit board 21 is connected to at least one flexible transmission line 25. Thereby the transmission line 25 can be bent to form as a figure or characters. The transmission line 25 is installed with a plurality of small light emitting elements 26. The light emitting elements 26 may have the same color or different colors. The battery 22 of the control circuit board 21 supplies power to the light emitting elements 26. The transmission line 25 having the light emitting elements 26 is wound and adhered to an inner wall of the colored and lighting decoration 15.

Thereby the colored and lighting decoration 15 of the decoration unit 10 have the effect of lighting up by the light emitting elements 26 of the light emitting unit 20. Thus the present invention has the functions of refracting light so as to present a very beautiful effect.

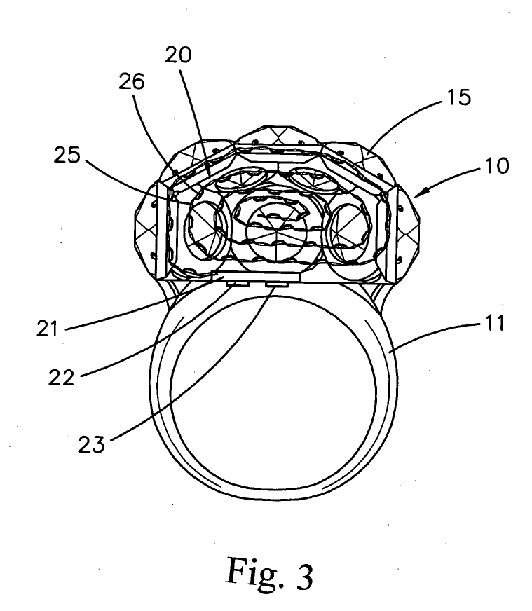

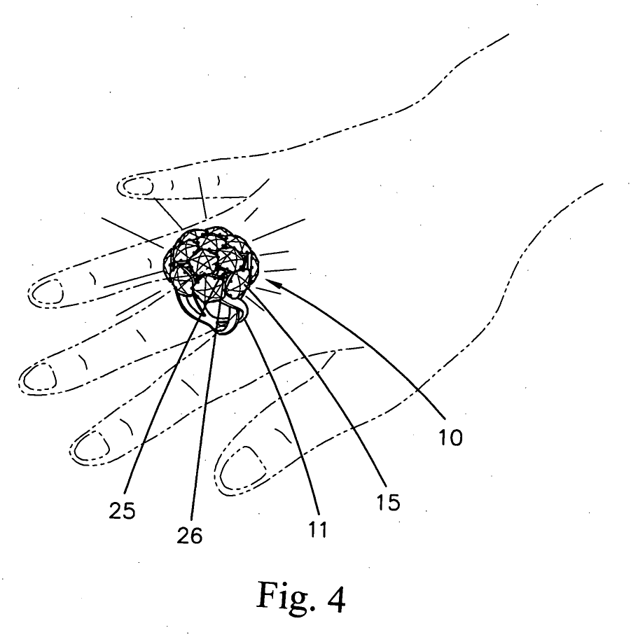

In use of the present invention, referring to FIGS. 3 and 4, the ring 11 of the decoration unit 10 can wear on one finger of the user. The colored and lighting decoration 15 exposes out. If the user presses the switch key 23, power will supply the light emitting elements 26 of the transmission line 25 so that the colored and lighting decoration 15 will present a beautiful light effect.

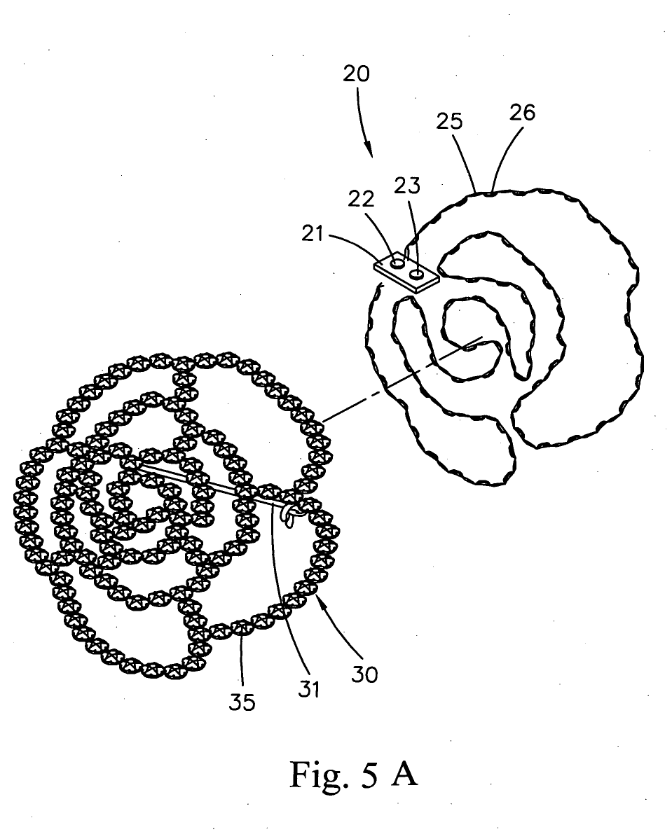

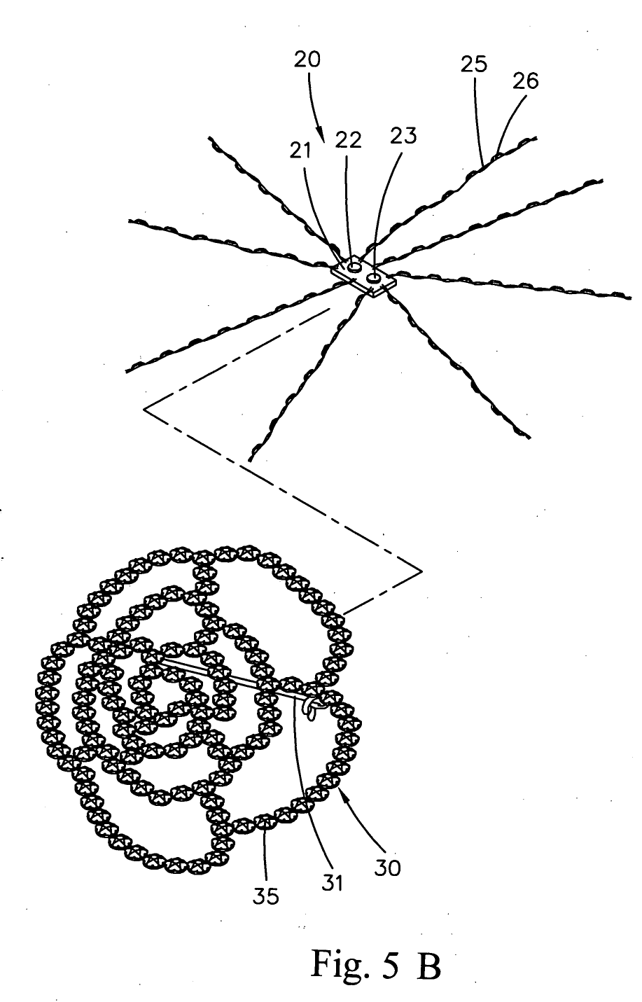

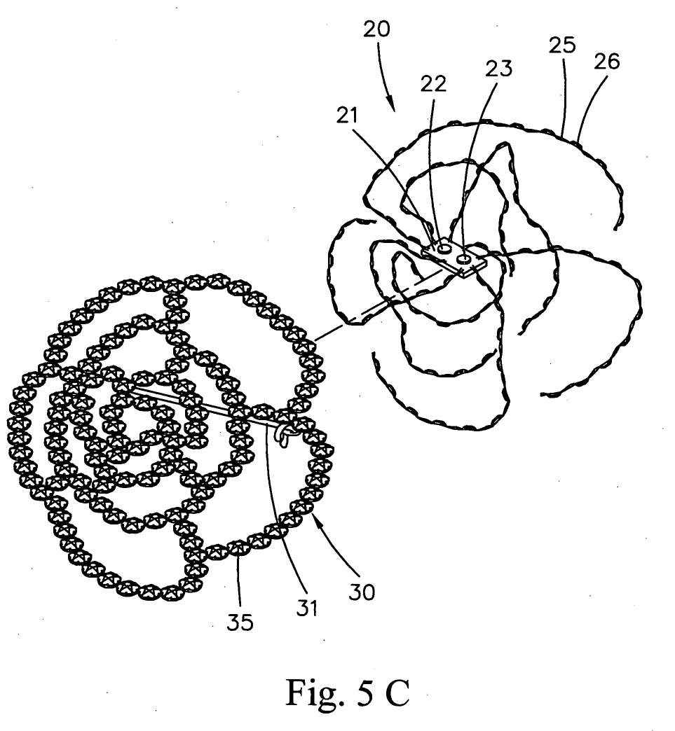

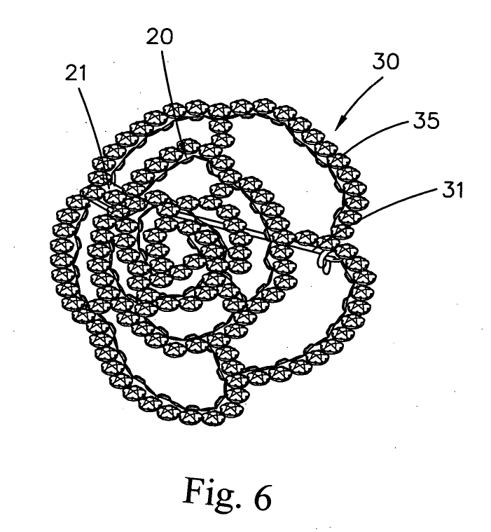

Referring to FIGS. 5A to 5C and FIG. 6, the second embodiment of the present invention is illustrated. The decoration unit 30 is a breast clip which has a clip 31. The clip 31 is installed with a colored and lighting decoration 35 which may be formed as characters, figures, like flowers. The colored and lighting decoration 15 may be a single color decoration or a multi-color decoration. The colored and lighting decoration 15, for example a polygonal manmade or natural diamond, crystal, jewel or glass so that when light passes through the colored and lighting decoration 15, the light is refracted to present a beautiful light effect. A light emitting unit 20 is formed by winding one flexible transmission line 25 (referring to FIG. 5A) or is formed by a plurality of transmission lines 25 which are arranged as radiating lines (referring to FIG. 5B) or a flower (referring to FIG. 5C). These examples can present beautiful light effect.

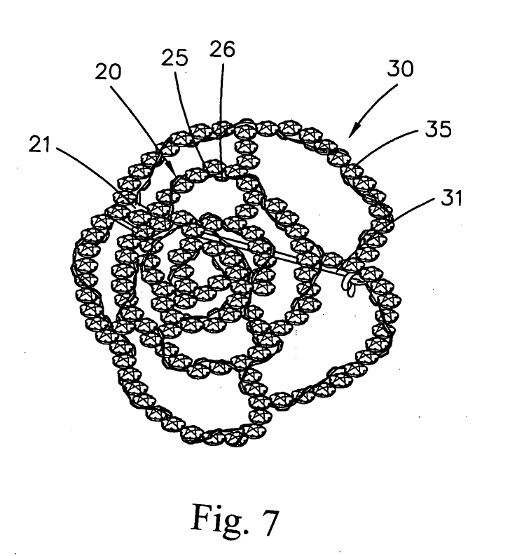

Referring to FIG. 7, in the present invention, the transmission line 25 can be wound around the periphery of the colored and lighting decoration 35 to present a beautiful light effect.

In the present invention, the transmission line is adhered to the decoration unit by one of winding, embedding, fastener tape, and sticky.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A light emitting decoration comprising:
a decoration unit having a colored and lighting decoration; the colored and lighting decoration being capable of refracting light as light passing therethrough;
a light emitting unit having at least one transmission line which is bendable to be formed as a figure or characters; the transmission line being installed with a plurality of light emitting elements; the transmission line being wound and adhered to the colored and lighting decoration; AND
the light emitting unit having a control circuit board with predetermined control way; and the control circuit board is installed with a battery as a power source and a switch key.

2. The light emitting decoration as claimed in claim 1, wherein the decoration has a ring which can be worn around a finger of a user.

3. The light emitting decoration as claimed in claim 1, wherein the decoration unit has a breast clip.

4. The light emitting decoration as claimed in claim 1, wherein the colored and lighting decoration is a single color or a multi-color decoration.

5. The light emitting decoration as claimed in claim 1, wherein the decoration unit is one of polyhedral manmade diamonds, polyhedral manmade crystals, polyhedral manmade jewels, polyhedral manmade glasses; polyhedral natural diamonds, polyhedral natural crystals, polyhedral natural jewels and polyhedral natural glasses.

6. The light emitting decoration as claimed in claim 1, wherein the light emitting elements have the same color or different colors.

7. The light emitting decoration as claimed in claim 1, wherein the light emitting elements have the same color or different colors.

8. The light emitting decoration as claimed in claim 1, wherein the transmission line is adhered to the decoration unit by one of winding, embedding, fastener tape, and sticky.
